(19) United States
(12) Patent Application Publication
(10) Pub. No.: US 2024/0397353 A1
(43) Pub. Date: Nov. 28, 2024

(54) ROUTER-BASED TROUBLESHOOTING IN A CLOUD-COMPUTING ENVIRONMENT

(71) Applicant: DISH Wireless L.L.C., Littleton, CO (US)

(72) Inventors: Daniel Steeves, Lakewood, CO (US); Javier Spina, Denver, CO (US); Mike Angeloff, Englewood, CO (US)

(21) Appl. No.: 18/647,833

(22) Filed: Apr. 26, 2024

Related U.S. Application Data
(60) Provisional application No. 63/504,704, filed on May 26, 2023.

(51) Int. Cl. H04W 24/08; G06F 9/455; H04L 43/02; H04L 43/0811

(52) U.S. Cl. CPC H04W 24/08; G06F 9/45558; H04L 43/02; H04L 43/0811; G06F 2009/45595

(57) ABSTRACT

A method for analyzing communication traffic at a base station of a cellular network is provided. The method includes logging into a router at the base station of the cellular network, where: the router is connected with a radio unit and a distributed unit, the radio unit, the router, and the distributed unit being located on-site as part of the base station. The method also includes loading, by the router, a container into a container engine being executed by the router. The method also includes capturing, controlled by the container loaded into the container engine of the router, packet data transmitted from a first component of the cellular network to a second component of the cellular network that is part of the base station.

### CROSS REFERENCE TO RELATED APPLICATIONS

This application claims priority to U.S. Provisional Patent Application No. 63/504,704, filed on May 26, 2023, the disclosure of which is incorporated by reference in its entirety for all purposes.

### BACKGROUND

Cellular networks are highly complex. Historically, cellular components tended to be sourced from one particular vendor, thus making the entity responsible for diagnosing and correcting a problem easy to identify. However, with the advent of the open radio access network (O-RAN) approach and component virtualization, components of cellular networks can be sourced from different vendors and can be executed as special-purpose software executed by general-purpose hardware. This arrangement, along with the complexity of modern 5G New Radio (NR) cellular networks, can benefit from improved component monitoring, analysis, and troubleshooting. Embodiments detailed herein can help address such needs.

### SUMMARY

Various arrangements for router-based troubleshooting in a cloud-computing environment are presented. One general aspect includes a method for analyzing communication traffic at a base station of a cellular network. The method includes logging into a router at the base station of the cellular network, where: the router is connected with a radio unit and a distributed unit, the radio unit, the router, and the distributed unit being located on-site as part of the base station. The method also includes loading, by the router, a container into a container engine being executed by the router. The method also includes capturing, controlled by the container loaded into the container engine of the router, packet data transmitted from a first component of the cellular network to a second component of the cellular network that is part of the base station.

Implementations may include one or more of the following features. In some embodiments, the method may include: analyzing the captured packet data between the first component of the cellular network and the second component of the cellular network. In some embodiments, the method may include: in response to analyzing the captured packet data, outputting a status of the connectivity between the first component and the second component. In some embodiments, the analyzing the captured packet data may include performing a performance analysis. In some embodiments, the cellular network is a 5G New Radio (NR) cellular network. In some embodiments, the 5G New Radio (NR) cellular network may include a 5G core executed on a cloud-computing platform. In some embodiments, the first component is the radio unit, and the second component the distributed unit. In some embodiments, the first component is a server executed on a cloud-computing platform, and the second component is the distributed unit. In some embodiments, the container is a Kubernetes container. In some embodiments, the container is loaded from a container image located at a server executed on a cloud-computing platform. In some embodiments, the container is loaded upon a request. In some embodiments, logging into the router is based on credentials. In some embodiments, the capturing may include: obtaining an IP address of the first component; obtaining an IP address of the second component; specifying a communication port; and capturing packet data transmitted over the communication port between the IP address of the first component and the IP address of the second component during a predetermined period. Implementations of the described techniques may include hardware, a method or process, or computer software on a computer-accessible medium.

Another general aspect includes a base station equipment of a cellular network. The base station equipment includes a base station. The base station equipment also includes a radio unit connected with the base station. The base station equipment also includes a distributed unit connected with the radio unit. The base station equipment also includes a router connected with the radio unit and the distributed unit. The router is configured to: load a container into a container engine being executed by the router; and capture, by the container loaded into the container engine of the router, packet data transmitted from a first component of the cellular network to a second component of the cellular network that is part of the base station equipment.

Implementations may include one or more of the following features. In some embodiments, the router is further configured to: analyze the captured packet data between the first component of the cellular network and the second component of the cellular network. In some embodiments, the cellular network is a 5G New Radio (NR) cellular network. In some embodiments, the router is further configured to: in response to analyzing the captured packet data, output a status of the connectivity between the first component and the second component. Implementations of the described techniques may include hardware, a method or process, or computer software on a computer-accessible medium.

Another general aspect includes a cellular network implemented using a cloud-computing platform. The cellular network includes a cellular network core. The cellular network also includes a centralized unit connected with cellular network core. The cellular network also includes a plurality of base stations. The cellular network also includes a plurality of radio units connected with the plurality of base stations, respectively. The cellular network also includes a plurality of distributed units connected with the plurality of radio units, respectively, and the centralized unit. The cellular network also includes a plurality of routers connected with one of the plurality of the radio units and one of the plurality of distributed units. At least one of the plurality of routers is configured to: load a container into a container engine being executed by the at least one of the plurality of routers; and capture, by the container loaded into the container engine of the at least one router, packet data transmitted from a first component of the cellular network to a second component of the cellular network.

Implementations may include one or more of the following features. In some embodiments, the cellular network core is a 5G New Radio (NR) cellular network core. In some embodiments, the at least one of the plurality of routers is further configured to: in response to analyzing the captured packet data, output a status of the connectivity between the first component and the second component. Implementations of the described techniques may include hardware, a method or process, or computer software on a computer-accessible medium.

### BRIEF DESCRIPTION OF THE DRAWINGS

FIG. 1A illustrates an embodiment of a 5G New Radio (NR) cellular network.

FIG. 1B illustrates an embodiment of a 5G core of the cellular network.

FIG. 2 illustrates an embodiment of a router-based troubleshooting architecture utilizing a router.

FIG. 3 illustrates an embodiment of router for router-based troubleshooting.

FIG. 4 illustrates an embodiment of a method for analyzing communication traffic at a base station of a cellular network.

### DETAILED DESCRIPTION

In a cloud-based 5G New Radio (NR) cellular network, network connectivity and performance analysis are desired. A distributed unit (DU) is often located on-site as part of a base station, while a centralized unit (CU) is often located on a remote server of the cloud-based 5G NR cellular network. The status of the connectivity between the DU and the CU is desired. Conventionally, a separate server is introduced between the DU and the CU to achieve packet capture. The separate server allows for capturing packet data transmitted between the DU and the CU. However, using a separate server increases the cost and manpower for deployment, initialization, and maintenance.

On the other hand, network performance analysis and monitoring is often achieved by using a virtual machine (e.g., a virtual machine provided by VMware Inc.). A virtual machine is a computing resource that uses software instead of a physical computer to run programs and deploy applications. One or more virtual “guest” machines run on a physical “host” machine. Each virtual machine runs its own operating system and functions separately from the other virtual machines, even when they are all running on the same host. This means that, for example, a virtual MacOS virtual machine can run on a physical PC. Virtual machine technology is used for many use cases across on-premises and cloud environments. However, a virtual machine is less efficient and runs slower than a full physical computer. Since a virtual machine runs its own operating system, it is considered heavyweight as compared to a container. Containers, on the other hand, are fully functional and portable cloud or non-cloud computing environments surrounding the application and keeping it independent from other parallelly running environments.

In accordance with embodiments of the present disclosure, a router located on-site as part of the base station is utilized for packet capture and network performance analysis. The router is connected with the radio unit (RU) and the DU, which are both located on-site as part of the base station. The router may also be connected with components of a cloud-based cellular network, such as a centralized unit. A container is loaded into a container engine executed by the router. Therefore, the router is capable of capturing packet data transmitted from a first component (e.g., the DU) of the cellular network to a second component (e.g., the CU) of the cellular network. As compared to a virtual machine, the router-based packet capture is lightweight because the container executed by the router uses only a portion of the processing and memory resources of the router. In the meantime, utilizing a cell-site router, which is an existing component located on-site as part of the base station equipment, lightweight packet capture and lightweight network performance analysis can be achieved, thus avoiding the additional cost and manpower resulting from introducing a separate server.

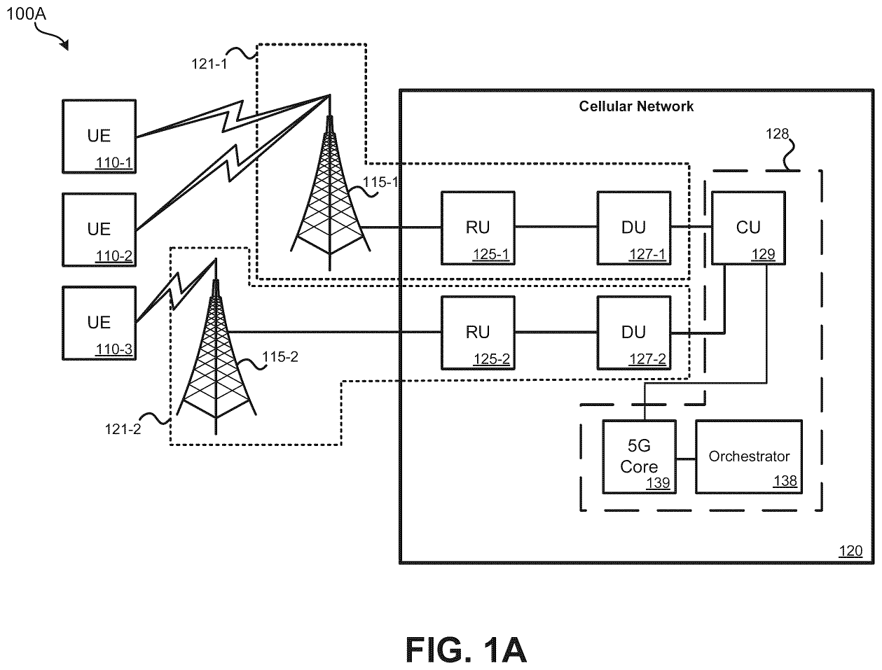

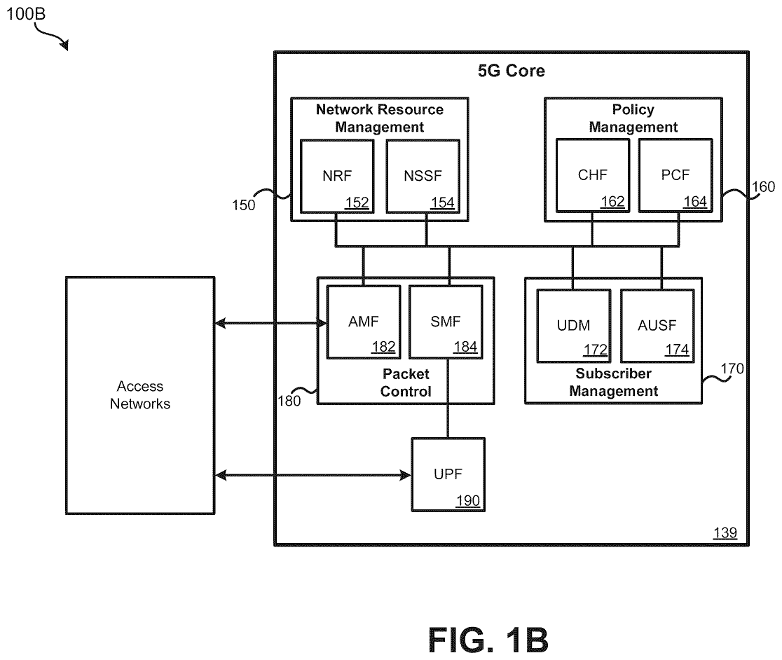

FIG. 1A illustrates an embodiment of a cellular network system 100 (“system 100”). System 100 can include a 5G New Radio (NR) cellular network; other types of cellular networks, such as 6G, 7G, etc., are also possible. System 100 can include: UE 110 (UE 110-1, UE 110-2, UE 110-3); base station 115; cellular network 120; radio units 125 (“RUs 125”); distributed units 127 (“DUs 127”); centralized unit 129 (“CU 129”); 5G core 139, and orchestrator 138. FIG. 1A represents a component level view. In an open radio access network (O-RAN), because components can be implemented as software in the cloud, except for components that need to receive and transmit RF, the functionality of the various components can be shifted among different servers, for which the hardware may be maintained by a separate cloud-service provider, to accommodate where the functionality of such components is needed.

UE 110 can represent various types of end-user devices, such as smartphones, cellular modems, cellular-enabled computerized devices, sensor devices, gaming devices, access points (APs), any computerized device capable of communicating via a cellular network, etc. UE 110 can also represent any type of device that has incorporated a 5G interface, such as a 5G modem. Examples include sensor devices, Internet of Things (IoT) devices, manufacturing robots; unmanned aerial (or land-based) vehicles, network-connected vehicles, etc. Depending on the location of individual UEs, UE 110 may use RF to communicate with various base stations of cellular network 120. As illustrated, two base stations 115 (BS 115-1, 115-2) are illustrated. Real-world implementations of system 100 can include many (e.g., thousands) of base stations, RUs, DUs, and CUs. BS 115 can include one or more antennas that allow RUs 125 to communicate wirelessly with UEs 110. RUs 125 can represent an edge of cellular network 120 where data is transitioned to wireless communication. The radio access technology (RAT) used by RU 125 may be 5G New Radio (NR), or some other RAT. The remainder of cellular network 120 may be based on an exclusive 5G architecture, a hybrid 4G/5G architecture, a 4G architecture, or some other cellular network architecture. Base station equipment 121 may include an RU (e.g., RU 125-1) and a DU (e.g., DU 127-1).

One or more RUs, such as RU 125-1, may communicate with DU 127-1. As an example, at a possible cell site, three RUs may be present, each connected with the same DU. Different RUs may be present for different portions of the spectrum. For instance, a first RU may operate on the spectrum in the citizens broadcast radio service (CBRS) band while a second RU may operate on a separate portion of the spectrum, such as, for example, band 71. One or more DUs, such as DU 127-1, may communicate with CU 129. Collectively, RUs, DUs, and CUs create a gNodeB, which serves as the radio access network (RAN) of cellular network 120. CU 129 can communicate with 5G core 139. The specific architecture of cellular network 120 can vary by embodiment. Edge cloud server systems outside of cellular network 120 may communicate, either directly, via the Internet, or via some other network, with components of cellular network 120. For example, DU 127-1 may be able to communicate with an edge cloud server system without routing data through CU 129 or 5G core 139. Other DUs may or may not have this capability.

Further detail regarding 5G Core 139 is provided in relation to FIG. 1B. 5G core 139, which can be physically distributed across data centers or located at a central national data center (NDC), can perform various core functions of the cellular network. 5G core 139 can include: network resource management components 150; policy management components 160; subscriber management components 170; and packet control components 180. Individual components may communicate on a bus, thus allowing various components of 5G core 139 to communicate with each other directly. 5G core 139 is simplified to show some key components. Implementations can involve additional other components.

Network resource management components 150 can include: Network Repository Function (NRF) 152 and Network Slice Selection Function (NSSF) 154. NRF 152 can allow 5G network functions (NFs) to register and discover each other via a standards-based application programming interface (API). NSSF 154 can be used by Access and Mobility Management Function (AMF) 182 to assist with the selection of a network slice that will serve a particular UE.

Policy management components 160 can include: Charging Function (CHF) 162 and Policy Control Function (PCF) 164. CHF 162 allows charging services to be offered to authorized network functions. Converged online and offline charging can be supported. PCF 164 allows for policy control functions and the related 5G signaling interfaces to be supported.

Subscriber management components 170 can include: Unified Data Management (UDM) 172 and Authentication Server Function (AUSF) 174. UDM 172 can allow for generation of authentication vectors, user identification handling, NF registration management, and retrieval of UE individual subscription data for slice selection. AUSF 174 performs authentication with UE.

Packet control components 180 can include: Access and Mobility Management Function (AMF) 182 and Session Management Function (SMF) 184. AMF 182 can receive connection- and session-related information from UE and is responsible for handling connection and mobility management tasks. SMF 184 is responsible for interacting with the decoupled data plane, creating updating and removing Protocol Data Unit (PDU) sessions, and managing session context with the User Plane Function (UPF) 190.

User plane function (UPF) 190 can be responsible for packet routing and forwarding, packet inspection, QoS handling, and external PDU sessions for interconnecting with a Data Network (DN) (e.g., the Internet) or various access networks. Access networks can include the RAN of cellular network 120 of FIG. 1A.

While FIGS. 1A and 1B illustrate various components of cellular network 120, it should be understood that other embodiments of cellular network 120 can vary the arrangement, communication paths, and specific components of cellular network 120. While RU 125 may include specialized radio access componentry to enable wireless communication with UE 110, other components of cellular network 120 may be implemented using either specialized hardware, specialized firmware, and/or specialized software executed on a general-purpose server system. In an O-RAN arrangement, specialized software on general-purpose hardware may be used to perform the functions of components such as DU 127, CU 129, and 5G core 139. Functionality of such components can be co-located or located at disparate physical server systems. For example, certain components of 5G core 139 may be co-located with components of CU 129.

In a possible O-RAN implementation, DUs 127, CU 129, 5G core 139, and/or orchestrator 138 can be implemented virtually as software being executed by general-purpose computing equipment, such as in a data center. Therefore, depending on needs, the functionality of a DU, CU, and/or 5G core may be implemented locally to each other and/or specific functions of any given component can be performed by physically separated server systems (e.g., at different server farms). For example, some functions of a CU may be located at a same server facility as where the DU is executed, while other functions are executed at a separate server system. In the illustrated embodiment of system 100, cloud-based cellular network components 128 include CU 129, 5G core 139, and orchestrator 138. In some embodiments, DUs 127 may be partially or fully added to cloud-based cellular network components 128. Such cloud-based cellular network components 128 may be executed as specialized software executed by underlying general-purpose computer servers. Cloud-based cellular network components 128 may be executed on a third-party cloud-based computing platform or a cloud-based computing platform operated by the same entity that operates the RAN. A cloud-based computing platform may have the ability to devote additional hardware resources to cloud-based cellular network components 128 or implement additional instances of such components when requested.

Kubernetes, or some other container orchestration platform, can be used to create and destroy the logical DU, CU, or 5G core units and subunits as needed for the cellular network 120 to function properly. Kubernetes allows for container deployment, scaling, and management. As an example, if cellular traffic increases substantially in a region, an additional logical DU or components of a DU may be deployed in a data center near where the traffic is occurring without any new hardware being deployed. (Rather, processing and storage capabilities of the data center would be devoted to the needed functions.) When the need for the logical DU or subcomponents of the DU no longer exists, Kubernetes can allow for removal of the logical DU. Kubernetes can also be used to control the flow of data (e.g., messages) and inject a flow of data to various components. This arrangement can allow for the modification of nominal behavior of various layers.

The deployment, scaling, and management of such virtualized components can be managed by orchestrator 138. Orchestrator 138 can represent various software processes executed by underlying computer hardware. Orchestrator 138 can monitor cellular network 120 and determine the amount and location at which cellular network functions should be deployed to meet or attempt to meet service level agreements (SLAs) across slices of the cellular network.

Orchestrator 138 can allow for the instantiation of new cloud-based components of cellular network 120. As an example, to instantiate a new DU, orchestrator 138 can perform a pipeline of calling the DU code from a software repository incorporated as part of, or separate from, cellular network 120; pulling corresponding configuration files (e.g., helm charts); creating Kubernetes nodes/pods; loading DU containers; configuring the DU; and activating other support functions (e.g., Prometheus, instances/connections to test tools).

A network slice functions as a virtual network operating on cellular network 120. Cellular network 120 is shared with some number of other network slices, such as hundreds or thousands of network slices. Communication bandwidth and computing resources of the underlying physical network can be reserved for individual network slices, thus allowing the individual network slices to reliably meet particular SLA levels and parameters. By controlling the location and amount of computing and communication resources allocated to a network slice, the SLA attributes for UE on the network slice can be varied on different slices. A network slice can be configured to provide sufficient resources for a particular application to be properly executed and delivered (e.g., gaming services, video services, voice services, location services, sensor reporting services, data services, etc.). However, resources are not infinite, so allocation of an excess of resources to a particular UE group and/or application may be desired to be avoided. Further, a cost may be attached to cellular slices: the greater the amount of resources dedicated, the greater the cost to the user; thus optimization between performance and cost is desirable.

Particular network slices may only be reserved in particular geographic regions. For instance, a first set of network slices may be present at RU 125-1 and DU 127-1, a second set of network slices, which may only partially overlap or may be wholly different from the first set, may be reserved at RU 125-2 and DU 127-2.

Further, particular cellular network slices may include some number of defined layers. Each layer within a network slice may be used to define QoS parameters and other network configurations for particular types of data. For instance, high-priority data sent by a UE may be mapped to a layer having relatively higher QoS parameters and network configurations than lower-priority data sent by the UE that is mapped to a second layer having relatively less stringent QoS parameters and different network configurations.

Components such as DUs 127, CU 129, orchestrator 138, and 5G core 139 may include various software components that are required to communicate with each other, handle large volumes of data traffic, and are able to properly respond to changes in the network. In order to ensure not only the functionality and interoperability of such components, but also the ability to respond to changing network conditions and the ability to meet or perform above vendor specifications, significant testing must be performed.

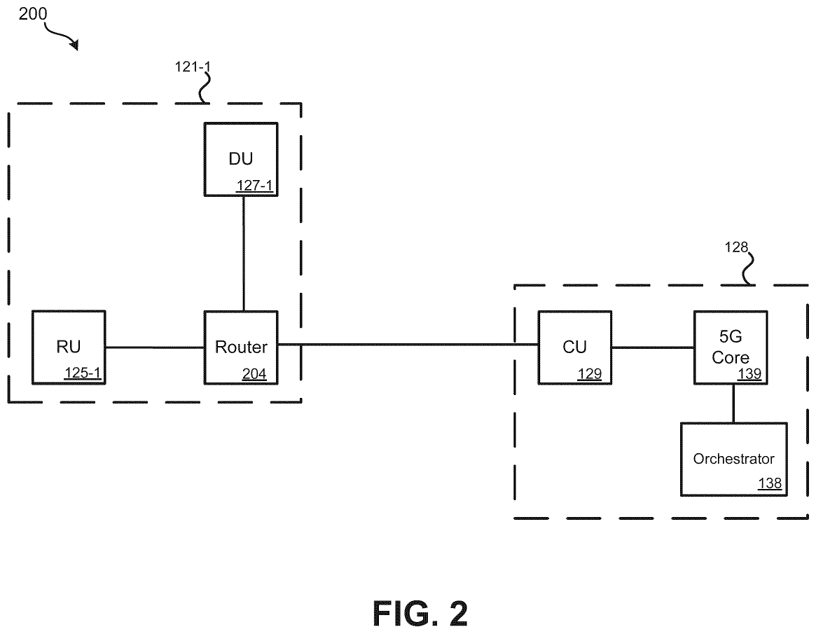

FIG. 2 illustrates an embodiment of a router-based troubleshooting architecture 200 utilizing a router 204. In the example shown in FIG. 2, the architecture 200 includes, among other components, RU 125-1, DU 127-1, router 204, and cloud-based cellular network components 128, which includes CU 129, 5G core 139, and orchestrator 138. RU 125-1, DU 127-1, CU 129, 5G core 139, and orchestrator 138 are the same to those discussed above with reference to FIGS. 1A and 1B, and details of which, therefore, are not repeated.

In the example shown in FIG. 2, RU 125-1, DU 127-1, and router 204 are located on-site as part of base station equipment 121-1, which may be situated remotely from cloud-based cellular network components 128. The base station equipment 121-1 is sometimes referred to as a “full base station.” In some embodiments, base station equipment 121-1 may be connected with cloud-based cellular network components 128 through Pass-Through Edge Data Center (PEDC), which primarily handles the routing of data and does not host any RAN or cellular core functions. In some embodiments, RU 125-1 and one or more antennas are mounted to a structure (e.g., a tower on the top of a building), while router 204 and DU 127-1 are housed at a base of the same structure.

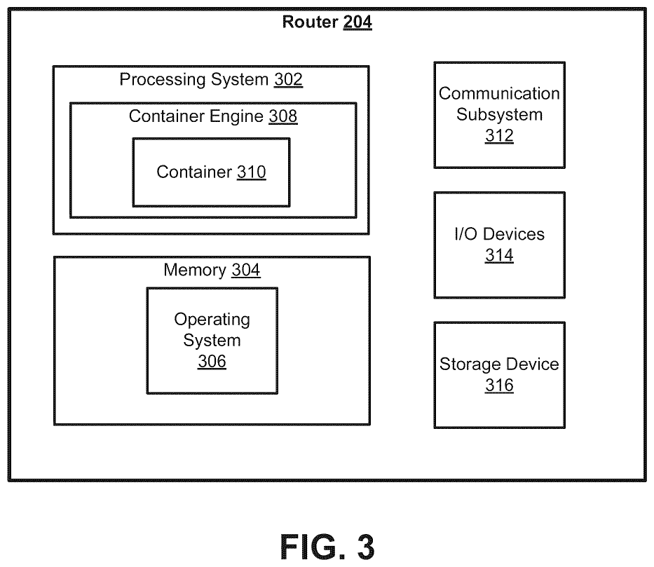

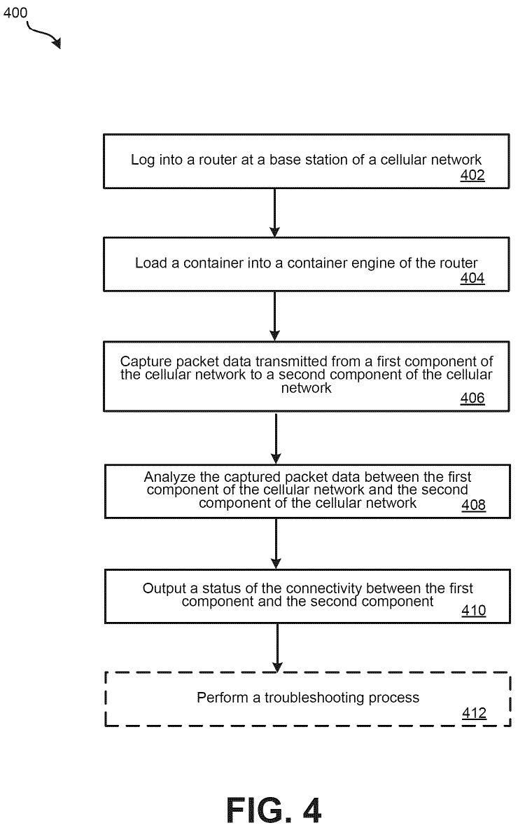

Router 204 is connected with RU 125-1, DU 127-1, and CU 129 of cloud-based cellular network components. Router 204 may route data between DU 127-1 and RU 125-1 and between DU 127-1 and CU 129. In addition, router 204 allows for router-based packet capture, troubleshooting, and analysis of communication traffic within base station equipment 121-1 and/or between base station equipment 121-1 and cloud-based cellular network components 128. Details of router 204 and how it operates will be discussed below with reference to FIGS. 3 and 4.

DU 127-1 is executed on a server, and a hypervisor (e.g., ESXi provided by VMware, Inc.) is installed on the server. Other functions, such as the F1 interface, which defines inter-connection of DU 127-1 and CU 129, may be executed on the same server. The F1 interface is separated into F1-C (control panel) and F1-U (user panel).

FIG. 3 illustrates an embodiment of router 204 for router-based troubleshooting. In the example shown in FIG. 3, router 204 includes, among other components, processing system 302, memory 304, and communication subsystem 312, I/O devices 314, and storage device 316, which may be electrically coupled via a bus. Processing system 302 may include one or more general-purpose processors and/or one or more special-purpose processors (such as digital signal processing chips, graphics acceleration processors, and/or the like). I/O devices 314 may include, for example, a mouse, a keyboard, a microphone, an antenna, a display device, a printer, a speaker, and/or the like.

Storage device 316 is configured to store data, including packet data captured by router 204, which will be discussed below. Storage device 316 may include one or more non-transitory storage devices. Storage device 315 may include, for example, a disk drive, a drive array, an optical storage device, a solid-state storage device, such as a random-access memory (“RAM”), and/or a read-only memory (“ROM”), which can be programmable, flash-updateable, and/or the like. Such storage devices may be configured to implement any appropriate data stores, including without limitation, various file systems, database structures, and/or the like.

Communication subsystem 312 is configured to provide the interface between router 204 and other external components. Communication subsystem 312 may include, for example, a modem, a network card (wireless or wired), an infrared communication device, a wireless communication device, and/or a chipset (such as a Bluetooth™ device, an 802.11 device and/or a WiFi device, a WiMax device, cellular communication facilities, etc.), and/or the like. Communications subsystem 630 may permit data to be exchanged with a network, other computer systems, and/or any other devices described herein.

Memory 304 may be a RAM or ROM device. Router 204 may include software elements, including an operating system 306, device drivers, executable libraries, and/or other code, such as one or more application programs, which may comprise computer programs provided by various embodiments, and/or may be designed to implement methods, and/or configure systems, provided by other embodiments, as described herein. Merely by way of example, one or more procedures described with respect to the method(s) discussed herein might be implemented as code and/or instructions executable by a computer (and/or a processor within a computer); in an aspect, then, such code and/or instructions can be used to configure and/or adapt a general purpose computer (or other devices) to perform one or more operations in accordance with the described methods.

It will be apparent to those skilled in the art that substantial variations may be made in accordance with specific requirements. For example, customized hardware might also be used, and/or particular elements might be implemented in hardware, software (including portable software, such as applets, etc.), or both. Further, connection to other computing devices, such as network input/output devices, may be employed.

FIG. 4 illustrates an embodiment of a method 400 for analyzing communication traffic at a base station of a cellular network. In the example shown in FIG. 4, the method 400 includes steps 402, 404, 406, 408, and 410. Additional operations may be performed. Also, it should be understood that the sequence of the various operations discussed above with reference to FIG. 4 is provided for illustrative purposes, and as such, other embodiments may utilize different sequences. These various sequences of operations are to be included within the scope of embodiments.

At step 402, a router at a base station of a cellular network is logged into. In the example shown in FIG. 2, router 204, which is located on-site as part of base station equipment 121-1, is logged into. As discussed above, router 204 is connected with RU 125-1, DU 127-1, and CU 129. In one implementation, router 204 is logged into using credentials such as administrator credentials. It should be understood that router 204 may be logged into by other suitable means in other implementations.

At step 404, a container is loaded into a container engine being executed by the router. Containerization technology has recently been vastly adopted by cloud computing platforms like Amazon Web Services (AWS). Containerization is operating system-level virtualization or application-level virtualization over multiple network resources so that software applications can run in isolated user spaces called containers in a cloud or non-cloud environment, regardless of type or vendor. Containers are fully functional and portable could or non-cloud computing environments surrounding the application and keeping it independent from other parallelly running environments. Individually each container simulates a different software application and runs isolated processes by bundling related configuration files, libraries, and dependencies. Multiple containers may collectively share a common operating system kernel.

In the example shown in FIG. 3, container engine 308 is configured to launch and manage container 310. Container 310 is the run-time instantiation of a container image. In one implementation, container engine 308 reads the container image of container 310 stored in a container image registry over, for example, a remote server and generates container 310 based on the container image. The process is also referred to as “loading container” 310. In one example, the remote server is a server executed on a cloud-computing platform. In one embodiment, container 310 is a Kubernetes container. It should be understood that other types of containers are within the contemplation of the disclosure. In one embodiment, container 310 is loaded upon a request. The request may be generated by an administrator.

At step 406, packet data transmitted from a first component of the cellular network to a second component of the cellular network is captured. In the example shown in FIG. 3, capturing packet data is controlled by container 310, and router 204 captures packet data transmitted from the first component to the second component. In one embodiment, the first component is RU 125-1 shown in FIG. 2, and the second component is DU 127-1 shown in FIG. 2. In another embodiment, the first component is DU 127-1, and the second component is CU 129. It should be understood other combinations of the first component and the second component are within the contemplation of the disclosure.

In one implementation, capturing packet data includes the following steps: (i) obtaining an IP address of the first component; (ii) obtaining an IP address of the second component; (iii) specifying a communication port; and (iv) capturing packet data transmitted over the communication port between the IP address of the first component and the IP address of the second component during a predetermined period.

At step 408, the captured packet data between the first component and the second component is analyzed. In some embodiments, the captured packet data is analyzed by processing system 302 of router 204 shown in FIG. 3. As such, the captured packet data is analyzed locally at the cell site, utilizing the computational capability of router 204 located on-site as part of base station equipment 121-1 shown in FIG. 2. In other embodiments, the captured packet data may be transmitted to a remote server, which has a larger computational capability than that of router 204, to be analyzed. In other words, the larger computational capability of a remote server executed, for example, on a cloud-computing platform, is also accessible if needed. The transmission of the captured packet data may be initiated by request from the administrator, by a determination that the volume of the packet data to be analyzed exceeds a predetermined value, or other suitable criteria.

In one example, analyzing the captured packet data includes performing a performance analysis. Various network performance parameters (e.g., bandwidth usage, throughput, latency, packet loss, retransmission, network availability, connectivity, and the like) can be derived by performing the performance analysis. Various network performance test types (e.g., call flow test, network traffic volume test, and the like) and associated network performance test conditions (e.g., executing a particular call flow, testing network performance under a specific traffic load, and the like) may be predetermined or adjusted by, for example, the administrator.

As discussed above, in one embodiment, the first component is DU 127-1, and the second component is CU 129. Router 204 captures packet data transmitted from DU 127-1 to CU 129. After analyzing the captured packet data, connectivity between DU 127-1 and CU 129 can be obtained. Network performance analysis can be achieved as well. Conventionally, a separate server is needed to monitor the connectivity between DU 127-1 and CU 129, resulting in additional cost and manpower. In contrast, utilizing router 204, which is an existing component located on-site as part of the base station equipment 121-1 shown in FIG. 2, lightweight packet capture and, therefore, lightweight network performance analysis can be achieved. It should be understood that the connectivity between DU 127-1 and other components may also be obtained. One of ordinary skill in the art would recognize many variations, modifications, and alternatives.

Also, as discussed above, in one embodiment, the first component is RU 125-1, and the second component is DU 127-1. Router 204 captures packet data transmitted from DU 127-1 to CU 129. After analyzing the captured packet data, connectivity between RU 125-1 and DU 127-1 can be obtained.

At step 410, a status of the connectivity between the first component and the second component is output in response to analyzing the captured packet data. The status of connectivity between the first component and the second component may be displayed by router 204 in some embodiments. The status of connectivity between the first component and the second component may, in other embodiments, be output to other components, such as DU 127-1, CU 129, or the like, for further processing. The transmission may be through communication subsystem 312 shown in FIG. 3. The status of connectivity between the first component and the second component may be stored in a log for future network performance analysis and troubleshooting.

It should be understood that method 400 may include additional steps. For example, at step 412, a troubleshooting process can be performed when the status of the connectivity between the first component and the second component indicates connectivity issues. A technician may be notified and dispatched to the base station to perform the troubleshooting process on-site. The status of the connectivity generated at step 410 can be utilized by the technician. Likewise, various network performance parameters derived by performing the performance analysis can be utilized by the technician as well.

Alternatively, an initial troubleshooting process may be performed remotely, and a technician is dispatched to the base station only when the initial troubleshooting process performed remotely is not successful. Similarly, during the troubleshooting process, the status of connectivity and other parameters derived from the network performance analysis may be utilized.

The methods, systems, and devices discussed above are examples. Various configurations may omit, substitute, or add various procedures or components as appropriate. For instance, in alternative configurations, the methods may be performed in an order different from that described, and/or various stages may be added, omitted, and/or combined. Also, features described with respect to certain configurations may be combined in various other configurations. Different aspects and elements of the configurations may be combined in a similar manner. Also, technology evolves and, thus, many of the elements are examples and do not limit the scope of the disclosure or claims.

Specific details are given in the description to provide a thorough understanding of example configurations (including implementations). However, configurations may be practiced without these specific details. For example, well-known circuits, processes, algorithms, structures, and techniques have been shown without unnecessary detail in order to avoid obscuring the configurations. This description provides example configurations only, and does not limit the scope, applicability, or configurations of the claims. Rather, the preceding description of the configurations will provide those skilled in the art with an enabling description for implementing described techniques. Various changes may be made in the function and arrangement of elements without departing from the spirit or scope of the disclosure.

Also, configurations may be described as a process which is depicted as a flow diagram or block diagram. Although each may describe the operations as a sequential process, many of the operations can be performed in parallel or concurrently. In addition, the order of the operations may be rearranged. A process may have additional steps not included in the figure. Furthermore, examples of the methods may be implemented by hardware, software, firmware, middleware, microcode, hardware description languages, or any combination thereof. When implemented in software, firmware, middleware, or microcode, the program code or code segments to perform the necessary tasks may be stored in a non-transitory computer-readable medium such as a storage medium. Processors may perform the described tasks.

Having described several example configurations, various modifications, alternative constructions, and equivalents may be used without departing from the spirit of the disclosure. For example, the above elements may be components of a larger system, wherein other rules may take precedence over or otherwise modify the application of the invention. Also, a number of steps may be undertaken before, during, or after the above elements are considered.

What is claimed is:

1. A method for analyzing communication traffic at a base station of a cellular network, the method comprising:
logging into a router at the base station of the cellular network, wherein:
the router is connected with a radio unit and a distributed unit, the radio unit, the router, and the distributed unit being located on-site as part of the base station;
loading, by the router, a container into a container engine being executed by the router; and
capturing, controlled by the container loaded into the container engine of the router, packet data transmitted from a first component of the cellular network to a second component of the cellular network that is part of the base station.

2. The method of claim 1, further comprising:
analyzing the captured packet data between the first component of the cellular network and the second component of the cellular network.

3. The method of claim 1, wherein the cellular network is a 5G New Radio (NR) cellular network.

4. The method of claim 3, wherein the 5G New Radio (NR) cellular network comprises a 5G core executed on a cloud-computing platform.

5. The method of claim 2, further comprising:
in response to analyzing the captured packet data, outputting a status of the connectivity between the first component and the second component.

6. The method of claim 2, wherein the analyzing the captured packet data comprises performing a performance analysis.

7. The method of claim 1, wherein the first component is the radio unit, and the second component the distributed unit.

8. The method of claim 1, wherein the first component is a server executed on a cloud-computing platform, and the second component is the distributed unit.

9. The method of claim 1, wherein the container is a Kubernetes container.

10. The method of claim 1, wherein the container is loaded from a container image located at a server executed on a cloud-computing platform.

11. The method of claim 1, wherein the container is loaded upon a request.

12. The method of claim 1, wherein logging into the router is based on credentials.

13. The method of claim 1, wherein the capturing comprises:
obtaining an IP address of the first component;
obtaining an IP address of the second component;
specifying a communication port; and
capturing packet data transmitted over the communication port between the IP address of the first component and the IP address of the second component during a predetermined period.

14. A base station equipment of a cellular network, the base station equipment comprising:
a base station;
a radio unit connected with the base station;
a distributed unit connected with the radio unit;
a router connected with the radio unit and the distributed unit, wherein the router is configured to:
load a container into a container engine being executed by the router; and
capture, by the container loaded into the container engine of the router, packet data transmitted from a first component of the cellular network to a second component of the cellular network that is part of the base station equipment.

15. The base station equipment of claim 14, the router is further configured to:
analyze the captured packet data between the first component of the cellular network and the second component of the cellular network.

16. The base station equipment of claim 14, wherein the cellular network is a 5G New Radio (NR) cellular network.

17. The base station equipment of claim 14, wherein the router is further configured to:
in response to analyzing the captured packet data, output a status of the connectivity between the first component and the second component.

18. A cellular network implemented using a cloud-computing platform, comprising:
a cellular network core;
a centralized unit connected with cellular network core;
a plurality of base stations;
a plurality of radio units connected with the plurality of base stations, respectively;
a plurality of distributed units connected with the plurality of radio units, respectively, and the centralized unit;
a plurality of routers connected with one of the plurality of the radio units and one of the plurality of distributed units, wherein at least one of the plurality of routers is configured to:
load a container into a container engine being executed by the at least one of the plurality of routers; and
capture, by the container loaded into the container engine of the at least one router, packet data transmitted from a first component of the cellular network to a second component of the cellular network.

19. The cellular network of claim 18, wherein the cellular network core is a 5G New Radio (NR) cellular network core.

20. The cellular network of claim 18, wherein the at least one of the plurality of routers is further configured to:
in response to analyzing the captured packet data, output a status of the connectivity between the first component and the second component.
